(19) United States
(12) Patent Application Publication
(10) Pub. No.: US 2010/0047002 A1
(43) Pub. Date: Feb. 25, 2010

(54) BRAILLE EMBOSSER

(76) Inventors: David A. Schleppenbach, Lafayette, IN (US); Kyle S. Rhodes, West Lafayette, IN (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/527,971

(22) PCT Filed: Feb. 21, 2008
(86) PCT No.: PCT/US08/54575

§ 371 Date: Aug. 20, 2009

Related U.S. Application Data
(60) Provisional application No. 60/891,005, filed on Feb. 21, 2007.

(51) Int. Cl. B41J 3/32

(52) U.S. Cl. 400/109.1

(57) ABSTRACT

A braille embosser device includes a plurality of hammers configured to strike a substrate and thereby produce thereon braille-readable projections. A controller is connected to the hammers and controls the striking by the hammers. The controller includes drivers each of which is connected to and drives a respective one of the hammers. A fault detection circuit detects a fault associated with one of the drivers and, in response to the fault, ceases the striking by the hammers.

### RELATED APPLICATION

The present invention claims the benefit of U.S. Provisional Patent Application Ser. No. 60/891,005, filed Feb. 21, 2007, and PCT application US2008/054575, filed Feb. 21, 2008, each of which is hereby incorporated by reference in its entirety herein.

### BACKGROUND OF THE INVENTION

1. Field of the Invention

The present invention relates to Braille embossers, i.e., machines for providing three-dimensional Braille patterns of “dots” on a medium such as paper.

2. Description of the Related Art

Braille embossers are typically built for low volume and low speed operation. However, recently enacted laws in favor of the disabled have mandated that an increasing number of documents be produced in Braille. Known Braille embossers are not capable of meeting increased demands for output and reliability and thus are not well suited for higher production levels.

Accordingly, what is neither anticipated nor obvious in view of the prior art is a Braille embosser that has levels of speed and reliability that are suitable for a high production environment.

### SUMMARY OF THE INVENTION

The present invention provides a Braille embosser that employs feedback to ensure that operation remains within tolerances. This results in the ability to operate with a higher level of throughput without breakdown.

The invention comprises, in one form thereof, a braille embosser device including a plurality of hammers for striking a substrate and thereby producing thereon braille-readable projections. A controller is connected to the hammers and controls the striking by the hammers. The controller includes a plurality of drivers. Each of the drivers is connected to and drives a respective one of the hammers. A fault detection circuit detects a fault associated with one of the drivers and, in response to the fault, ceases the striking by the hammers.

The invention comprises, in another form thereof, a braille embosser device including a plurality of hammers for striking a substrate and thereby producing thereon braille-readable projections. A controller is connected to the hammers and controls the striking by the hammers. The controller includes a plurality of drivers. Each of the drivers is connected to and drives a respective one of the hammers. At least one sensor arrangement senses the striking by the hammers and controls the drivers dependent upon the sensed striking by the hammers.

The invention comprises, in yet another form thereof, a braille embosser device including a two-dimensional array of hammers for striking a substrate and thereby producing thereon braille-readable dots. The dots are arranged in braille cells of six dots. The cells are arranged in rows extending in an x-direction and columns extending in a y-direction. Each of the hammers has a different, respective position in the x-direction. Each pair of hammers that have adjacent positions in the x-direction are offset in the y-direction from each other by a distance equivalent to at least three of the braille cells.

An advantage of the present invention is that the embosser has greater speed and reliability than known embossers.

Another advantage is that the punching of the dots is staggered for greater speed and more efficient cooling.

A further advantage is that the electrical power used in the punching process is adjustable via pulse width modulation. Thus, the power may be adjusted to compensate for changing mechanical conditions of the embosser, and may be adjusted to suit particular application requirements.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention.

FIG. 1 is a block diagram of one embodiment of an embosser device of the present invention.

FIG. 2 is a simplified hammer driver circuit schematic.

FIG. 3 is a perspective view of the embosser device of FIG. 1.

FIG. 4 is a side view of the embosser device of FIG. 3.

FIG. 5 is a rear view of the embosser device of FIG. 3 along lines 5-5.

FIG. 6 is a front view of the embosser device of FIG. 3.

FIG. 7 is a top view of the embosser device of FIG. 3.

FIG. 8 is a cross-sectional view of the print head assembly of the embosser device of FIG. 3.

FIG. 9 is a perspective view of the print head assembly of FIG. 8 with the backing plate and rubber backing removed.

FIG. 10 is a plan top view of the hammer plate of the print head assembly of FIG. 8.

FIG. 11 is a schematic plan view of the layout of positive and negative dots on a sheet of paper as produced by the print head assembly of FIG. 8.

FIG. 12 is a schematic plan view of an embossing pattern produced by the print head assembly of FIG. 8.

FIG. 13 is a first step of a four-step repeating fire sequence according to one embodiment of an embossing method of the present invention.

FIG. 14 is a second step of a four-step repeating fire sequence according to one embodiment of an embossing method of the present invention.

FIG. 15 is a third step of a four-step repeating fire sequence according to one embodiment of an embossing method of the present invention.

FIG. 16 is a fourth step of a four-step repeating fire sequence according to one embodiment of an embossing method of the present invention.

FIG. 17 is a cross-sectional view of another embodiment of a print head assembly of the present invention.

FIG. 18 is a perspective view of the backing plate of the print head assembly of FIG. 17.

FIG. 19 is a perspective view of the backing plate of FIG. 18 with load cells mounted therein.

FIG. 20a is a perspective view of a load cell of FIG. 19.

FIG. 20b is a cross-sectional view of the load cell of FIG. 20a.

FIG. 20c is a plan view of the load cell of FIG. 20b along line 20c-20c.

FIG. 21 is a side view of an anvil of the print head assembly of FIG. 17 engaging a load cell.

### DETAILED DESCRIPTION OF THE PRESENTLY PREFERRED EMBODIMENTS

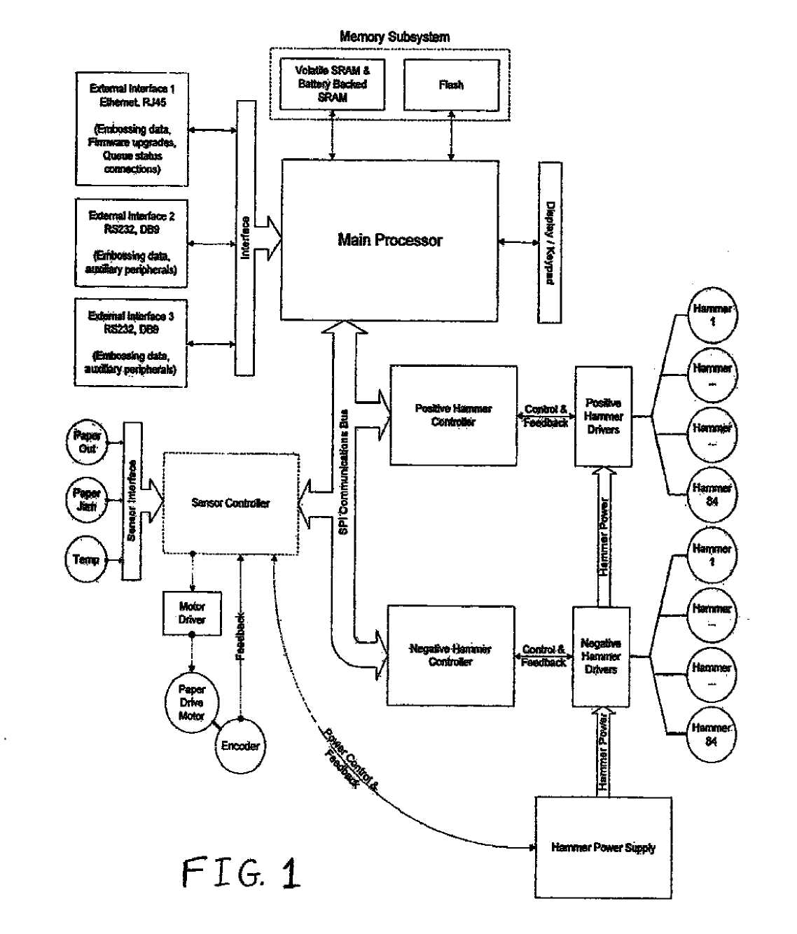

The embosser of the present invention may be used to produce high-speed, large-volume Braille output for professional Braille production facilities. The embosser may be capable of converting electronic document files into a pattern of embossed dots on a substrate, such as a fiber web, or a sheet of paper in a particular embodiment, as a hard-copy. There are many components of the device needed in order to accomplish this complex task (refer to FIG. 1).

As can be seen in FIG. 1, the core of the device is a main processor, which handles the data processing and allocation of functions to the individual components. This processor can be interfaced to the outside via a plurality of inputs including Ethernet, RS232, USB, and other traditional computer data interface methods. The inputs can communicate the Embossing Data, Firmware Upgrades, Embossing Queue Status reports, Auxiliary peripherals, and so forth.

The Main Processor also has a plurality of memory storage components. This memory can store the Firmware data, Embossing data, Queue status information, and so forth. It can also serve as a memory cache for purposes of assisting the main processor.

Finally, the Main Processor is connected to a plurality of outputs. Some of these outputs are reserved for user interaction; for example, the device can have a display and/or keypad for the user to enter commands or to read out the status of the device. It can also have a speaker, for producing speech output for “hands-free” operation, and even alternate display devices such as a Refreshable Braille Display in the event that the user is blind. Other outputs are reserved for internal communication with other components of the device such as the hammer controllers, sensor controller, and so forth.

The actual production of the Braille dots is an electromechanical process. After converting the text input into a series of instructions for the Hammer Controllers, the device then feeds paper through a mechanical assembly that allows the paper to travel past a large array of Hammers (solenoids) which pound dots into the page and produce the final product. The exact timing of the Hammers and the control of the paper travel may be very precise in order to correctly place the dots on the page. In addition, exacting care may be taken with the mechanical components; for example, proper paper tensioning may be undertaken in order to prevent slippage or “gear slop” from affecting the output.

### Inputs

The Embossing Data is generally formatted as an ASCII text file which consists of characters in a particular language (such as English). These characters are eventually converted by the Main Processor into a pattern of hammer impacts which results in a Braille “character” or Cell composed of raised dots. The other data inputs are likewise composed of traditional means of data storage such as ASCII, XML, HTML, and so forth.

### Memory and Main Processor

The main memory units interface with the processor via traditional computer bus/interface techniques. The device can have volatile memory such as SRAM or battery-backed SRAM. It can also utilize flash memory or a variety of other traditional memory storage units.

The Main Processor is composed of a microcontroller that is suited to the task; for example, the Rabbit R3000 controller can be used, although a variety of conventional controllers would be suitable.

### Outputs

There are two categories of output for the device. First, the device has outputs designed for user interaction and status reports. For example, a display and/or keypad can be used by the user to read out status information, view various data currently in the queue or processor system, or to effect commands to the embosser such as “Test Pattern”, “Number of Copies”, “Cancel Job”, and other traditional printer commands.

The second category of output is more complex. The main processor may communicate with the other components of the device via a bus, which can be composed of an SPI Communications Bus or a variety of other traditional electronic bus connections. The other components include the Hammer controllers (both positive and negative) and the Sensor Controller, among other possibilities.

### Hammer Controllers

There are two sets of Hammer Controllers: a “Positive” Hammer controller and a “Negative” Hammer controller. Respectively, these controllers influence the firing pattern of the hammers on either side of the paper. Similar to the Main Processor, the controllers are composed of electronic controller components suitable for the task. For example, the Atmel ATMEGA16 controller can be used, or a variety of other conventional controller devices.

The Hammer Controllers thus interface with the Hammer Drivers (both positive and negative) via a control and feedback loop system. This system ensures that the hammer drivers operate within the correct parameters needed to effect the appropriate hammer movement, in turn producing the desired dot pattern on the paper. The Hammer Driver circuits are powered by the Hammer Power Supply via a conventional power bus. The power from the power supply is regulated and/or passed to the individual hammers by the instructions from the Hammer Controllers, the Hammer Driver Circuits, and also by feedback from the Sensor Controller and Sensor circuits.

### Hammer Drivers

Each Hammer Driver (both Positive and Negative) is connected to the respective Hammer Controller and to the Hammer Power Supply. The Hammer Driver circuitry is carefully designed in order to provide the appropriate “burst” of power needed for each hammer to effect an impact on the paper capable of raising a permanent dot within the specifications required. This impact level can be regulated using techniques such as Pulse Width Modulation to provide a varying amount of force exerted by the hammer on the paper. This results in less wear on the mechanical components, as the Hammer Drivers can set the hammer impacts to the minimum energy expenditure needed to create a dot within specifications. Alternately, dot size, shape, and height can be adjusted by regulating the impact level using the Hammer Drivers.

### Hammer Power Supply

The Hammer Power Supply is composed of a variety of components designed for the production, storage, and regulation of high power levels needed to operate the many Hammers in the device. In particular, the device can operate at a high current level (much higher than standard household appliances). For safety and reliability reasons, the hammer power supply was designed with excess power capacity to account for the large power demands of a plurality of high-current Hammers (solenoids) operated at a high firing frequency. The Hammer Power Supply contains multiple large can capacitors that are capable of handling high current discharges. The Hammer Power Supply also includes a soft-charge circuit and intelligent monitoring to allow for safe operation due to its large capacity. The output voltage of the supply is monitored by the onboard microcontroller during the charging process at the start of embossing. If the charging rate is too low, the supply is immediately switched off and the machine indicates the error. For example, this could occur if one of the solenoid drivers is shorted. In addition to preventing short-circuiting, melting, fire, or other damage to the device this also serves as an important safety feature for the user.

### Hammers

The Hammers are composed of Solenoids with a special mechanical tip that is designed to impart a dot on a piece of paper when the tip impacts the paper. The Hammers are designed in concert with Anvils, which are negative or positive impressions of the tip that reside in the base plate of the embosser. As paper travels through the base plate between the Hammers and Anvils, individual impacts can “crimp” the paper between Hammer tip and Anvil, creating a permanent embossed dot.

### Hammer Mounting Plates

The Hammers are located in a Hammer Mounting Plate, in a precise matrix arrangement which accounts for all possible desired locations of Braille dots on the output page. A typical Braille page can consist of 6,000 individual dots, which are arranged in cells of 6 dots each. These cells are generally arranged in rows of approximately 42 cells, with approximately 25 lines per page.

Opposite the Hammer Mounting Plate is an Anvil Mounting Plate which consists of a corresponding pattern of anvils designed to receive the Hammer impacts and provide the crimping action that produces the final embossed dot in the paper. This Anvil Mounting Plate is backed with a sheet of rubber or similar material designed to absorb impacts and reduce vibration and noise. It can also be lined with sensors designed to detect the Hammer impacts and determine if the resultant dot is well-formed or invalid.

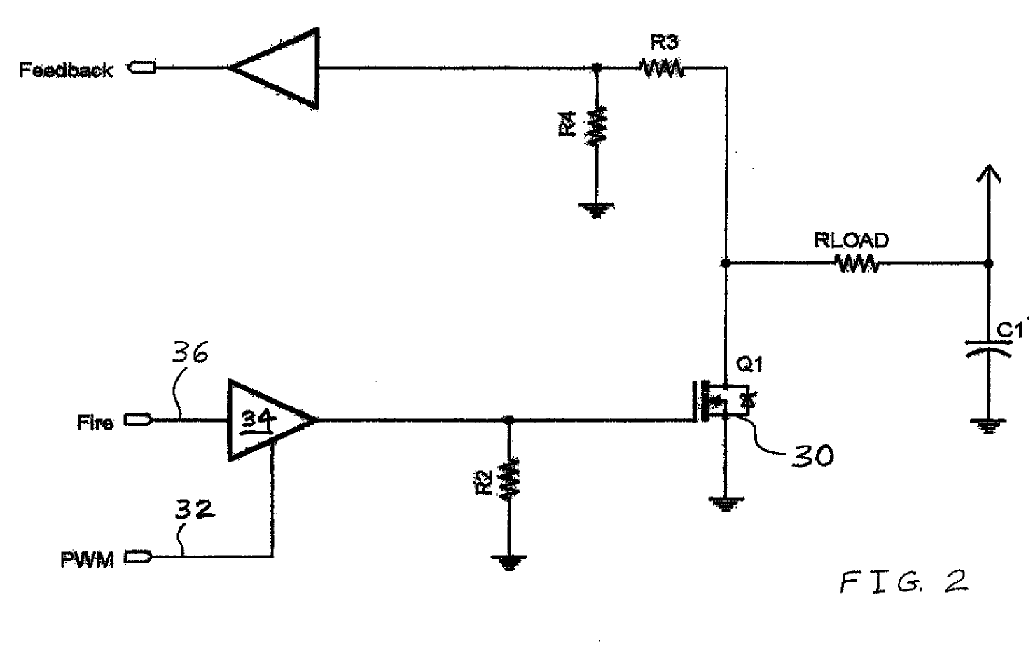

FIG. 2 is a simplified hammer driver circuit schematic. The “Feedback”, “Fire” and “PWM” (pulse width modulation) pins are represented by “Control & Feedback” in FIG. 1. “RLOAD” in FIG. 2 represents one of the eighty-four hammers in FIG. 1. The ‘Fire’ input is a pulse (its width is about 2 ms, i.e., time that it is “high”) generated from the hammer microcontroller that initiates the hammer fire by enabling the low side driver transistor 30. When this occurs, the ‘Feedback’ pin will output the actual state of the load. A ‘0’ indicates the driver is conducting the low side of the hammer to GND. If a ‘1’ is read then the driver is not conducting properly. During the idle state, when the ‘Fire’ input is ‘0’, the feedback pin will output a ‘1’ indicating transistor 30 is not conducting. If a ‘0’ is output, the driver is conducting unexpectedly. This is discussed in more detail below with reference to Table 1, wherein the ‘Fire’ input to designated “Driver Input”, the ‘Feedback’ pin is designated “Network Output”, the idle state is designated by “no Fire”, and the non-idle state is designated “Fire”.

During the printing operation the microcontroller goes through these steps for each fire of the hammers:

(‘output’ and ‘input’ are referring to the hammer driver circuit input or output, not the microcontroller input or output)
1. Check all ‘Feedback’ buffer outputs and assure they read as ‘1’ indicating none of the drivers are conducting unexpectedly.
2. Enable the appropriate ‘Fire’ inputs to turn on the driver transistors for the desired hammers.
3. Scan the ‘Feedback’ buffer output. The ‘Feedback’ outputs are compared with the enabled ‘Fire’ inputs to determine any fault conditions (‘Fire’ is equal to ‘Feedback’—Fault).
4. Repeat step 3 until the fire time has been reached (2 ms) OR a fault condition occurs, in which case stop the machine and indicate the hammer number.

The ‘PWM’ input may enable/disable the hammer driver at a set frequency and a varying duty cycle in order to vary the apparent current the hammer receives. The software will count the number of faults and only throw an error if this number is higher than a set threshold.

Some problems with solenoid hammer embossing are that they are expensive to replace and over time their strength (usefulness) decreases. If the system is expanded to allow for individual Pulse Width Modulated control lines for each driver coupled with an electromechanical feedback mechanism, the system can adapt to changing hammer strengths individually over time. Essentially the existing circuit completes the electrical feedback loop, whereas the future additions also close the mechanical feedback loop. Multiple strain gauge load cells (or equivalent) are implemented to monitor the hammer impact force imparted through the paper to the anvil. Not only does this setup provide for adaptive firing of the hammers to increase their useful life, it allows for the detection of malformed dots and purely mechanical problems with the system that could prevent a hammer from hitting the anvil.

### Paper Handling

The Paper Handling System is designed to allow the paper to travel between the Hammer Plate and the Anvil Plate in a horizontal orientation, such that the Hammers can effect dots onto the paper in predefined patterns via impact. The mechanics of the system are designed with great care, allowing for precise control of the paper motion in a transverse, perpendicular fashion slidably located between the mounting plates. However, the paper motion in the other direction (side-to-side with respect to the Hammers) is carefully constrained via mechanical tractor feeds and Paper Tensioning systems in order to prevent inappropriate paper motion from disturbing the precise pattern of dots embossed on the page.

### Sensor Controllers

There can also be a plurality of Sensor Controllers also connected to the Main Processor via the bus. These Sensor Controllers are responsible for detecting certain facets of the performance of the device and providing feedback to the various control circuits and motors in order to ensure that the device is operating within normal parameters. The Sensors and Effectors (Motors and Drivers) controlled by the Sensor Controller include Paper Handling System Sensors and Motors, the Hammer Power Supply/Fault Detection System, the Anvil Impact Sensors, and so forth.

### Hammer Fault Detection and Feedback

A novel circuit monitors each hammer driver individually in order to determine if it is functioning properly. The input of the circuit is tapped on the high side of the driver which connects to the low side of a hammer. This is achieved using a special resistor network. The network is connected to the high side of each hammer driver transistor. The output of each network is fed into an input buffer so it can be read by the microcontroller to determine the status of the transistor. The network outputs the state of the hammer solenoid corresponding to the current drive of the transistor. A number of fault conditions can be detected with this setup. The following table illustrates these conditions:

TABLE 1
Hammer Fault Detection Truth Table

| | Driver | Network | | |
|---|---|---|---|---|
| Operation | Input | Output | Fault? | Description |
| No Fire | 0 | 1 | No | The hammer connection is intact |
| No Fire | 0 | 0 | Yes | The hammer connection is open, the |
| | | | | hammer supply has a fault, or the driver |
| | | | | is shorted |
| Fire | 1 | 1 | Yes | The driver is failing to conduct |
| Fire | 1 | 0 | No | The driver is conducting, hammer firing |

There are several advantages to these fault detection circuits. As soon as a problem with a driver occurs the machine is stopped and the hammer supply is discharged. This prevents any further damage to the hammer control circuits beyond what caused the fault. This is extremely important due to the very high current capabilities of the hammer supply. Another advantage is quality. For instance, if a bad connection forms with a hammer it is immediately detected before thousands of pages of Braille are printed with missing dots. The implementation of this circuit also allows for reliable and confident unattended operation. Any chance of a fire hazard is eliminated with these novel safety features coupled with traditional fuses. Not only does this provide for a much safer unit, it also prevents the machine from destroying itself if there was any sort of electrical problem in the system.

The Hammer Power Supply is also regulated by the Sensor Controller (FIG. 1) using a Power Control and Feedback technique similar to the system used between the Hammer Controllers and Hammer Drivers.

### Paper Handling Sensors

The Paper Handling Sensors are monitored by the Sensor Controller, and are designed to provide critical feedback to the device in the event of problems or as the paper moves mechanically through the system. For example, optical and/or mechanical sensors can determine the “Paper Out” condition, the “Paper Jam” condition, or an “Overheating” condition internally to the unit, among other possibilities. In the event of a problem, these sensors provide feedback to the Sensor Controller, which in turn effects an output on the display (e.g., the display reads “Paper Out”) or controls the Hammer Power Supply directly (e.g., shuts down in the event of overheating).

### Paper Handling Motors

The paper travel is controlled by the Sensor Controller which is connected to a Motor Driver and an optional Encoder, both of which are in turn connected to a Paper Drive Motor. This system allows the device to precisely move the paper between the Mounting Plates and allows for the precise impact pattern needed to create the embossed dots.

### Cooling System

The device also has an intricate cooling system designed to provide ample air cooling for the many electromechanical parts that can overheat. This system is composed of air cooling fans (13 fans in one embodiment) and other cooling technologies, strategically positioned to provide a high level of airflow around the components such as the Hammers, Hammer Power Supply, and Hammer Drivers which heat up during operation.

### Embosser Queue Software

The device can be controlled externally using the Embosser Queue Software. This software is designed to provide a rich environment for the monitoring and control of print jobs sent to the embosser. For example, the software can provide instant feedback via Email, Text Messaging, or Instant Messaging when the paper is out, a job has ended, or an error occurred. The main interface is via an HTML page which is dynamically updated as the jobs process through the system.

The Emboss Queue System is a collection of dynamic web pages that allow monitoring and control of all connected embossers. In addition to the normal printing operations, the system logs a multitude of information. This includes the embossing history, the number of individual hammer fires, maintenance information, etc.

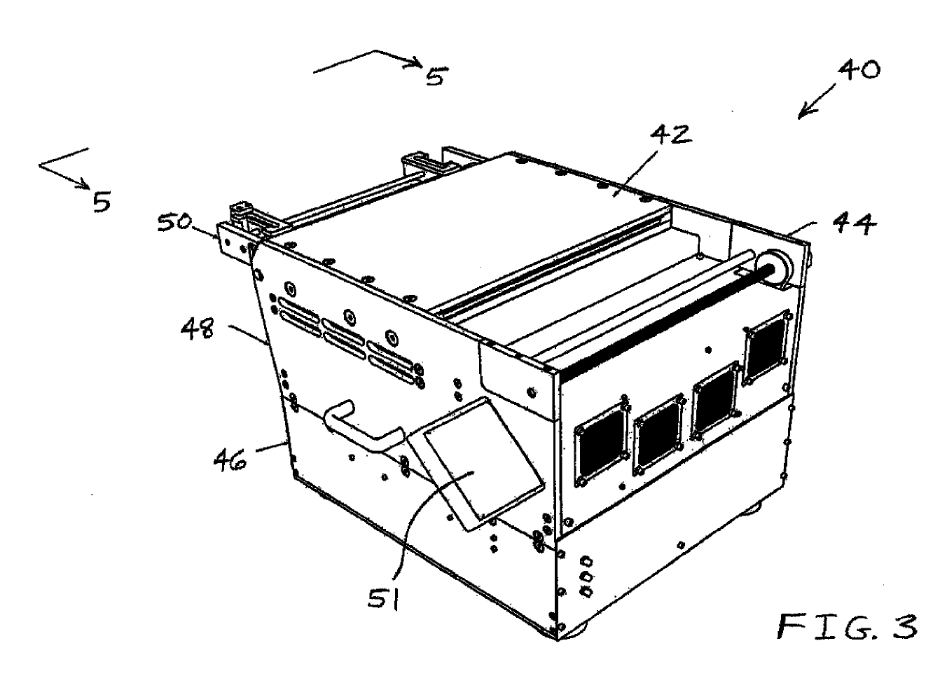

FIG. 3 is a perspective view of an embosser 40 depicted in block diagram in FIG. 1. Embosser 40 includes a print head assembly 42, a tractor feed assembly 44, a power supply assembly 46, a main chassis assembly 48, a paper tensioner assembly 50, and a control panel 51.

Embosser 40 consists of two main assemblies, power supply assembly 46 and main chassis assembly 48, both of which are in the form of an enclosure. Main chassis assembly 48 is attached ton top of the power supply assembly 46, such as via screws. The power supply assembly 46 contains the all of the equipment necessary to convert the mains power (115/230V) to the required DC voltages of 5V, 12V, and 36V. The 5V/12V supplies are produced using standard off-the-shelf switching power supplies. The 36V supply is used only for driving the hammers (solenoids) and is custom built within the enclosure. The power supply is large enough to provide the hammers with sufficient striking power under all conditions. In one embodiment, the 36V supply consists of a large custom made toroid transformer capable of producing 36V at 50 A continuous current. The power is filtered using a large capacitor bank, which also doubles as power storage for the large bursts of current necessary to fire the hammers. Given the large size and weight of these components (mainly the transformer), the power supply enclosure makes up the bottom half of the machine. This puts the center of gravity low on the device, increasing its stability and increasing safety.

The top half of embosser 40 consists of print head assembly 42 at the top, and tractor feeds for guiding the paper before and after the print head, which is all part of main chassis assembly 48. The positive and negative hammer driver circuit boards are contained within main chassis assembly 48 along with the main control board. The hammer driver boards are located directly beneath print head assembly 42 which contains all 168 hammers. The hammers are electrically connected directly to the hammer boards via discrete two-pin cable assemblies. The whole print head assembly 42 is mounted on a “hinge shaft” and stabilized with a gas spring. This allows the assembly to open, revealing the hammer boards and all wiring to the hammers for easy service. In the down position (normal operation), print head assembly 42 is attached to the main chassis assembly 48, such as via screws, to provide maximum strength and rigidity of main chassis assembly 48.

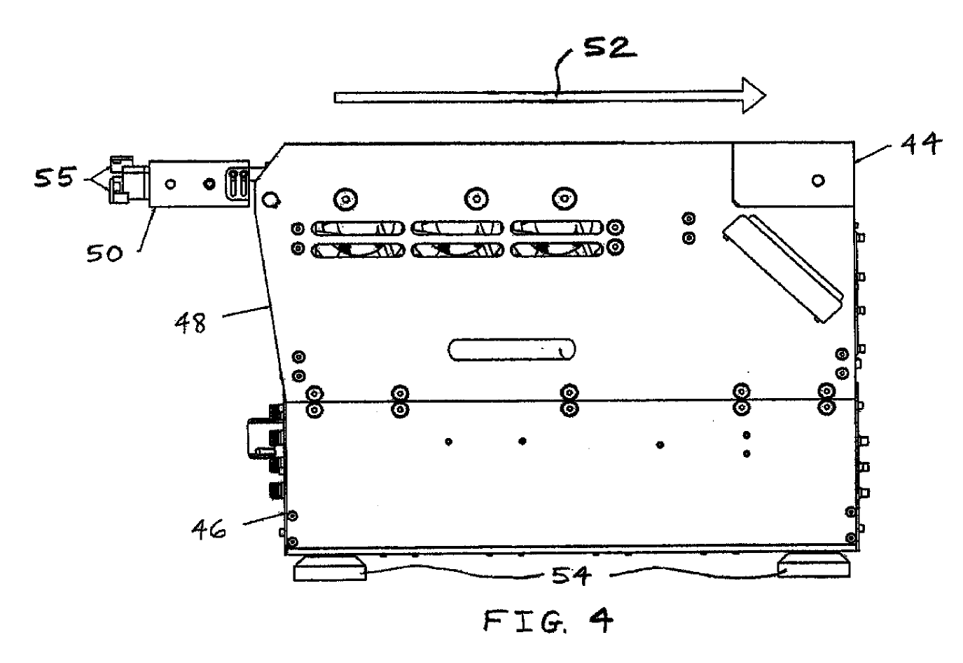

Embosser 40 feeds the paper in a horizontal direction, indicated by arrow 52 in FIG. 4. The horizontal feeding of the paper simplifies the design of the enclosures and maximizes the ability for embosser 40 to cool itself. The paper is stacked behind or beneath embosser 40 (depending on the stand used) and is fed into the rear paper tensioner tractor feed assembly 50. This tractor feed assembly 50 guides the paper into print head assembly 42 for embossing. The paper exits print head assembly 42 and then enters the main tractor feed. This tractor feed is driven by a precise stepper motor that in turn pulls the paper through embosser 40. The combination of these two tractor feed assemblies ensures the paper is embossed on in a precise fashion. Also shown in FIG. 4 are vibration-dampening feet 54 and paper jam sensors 55.

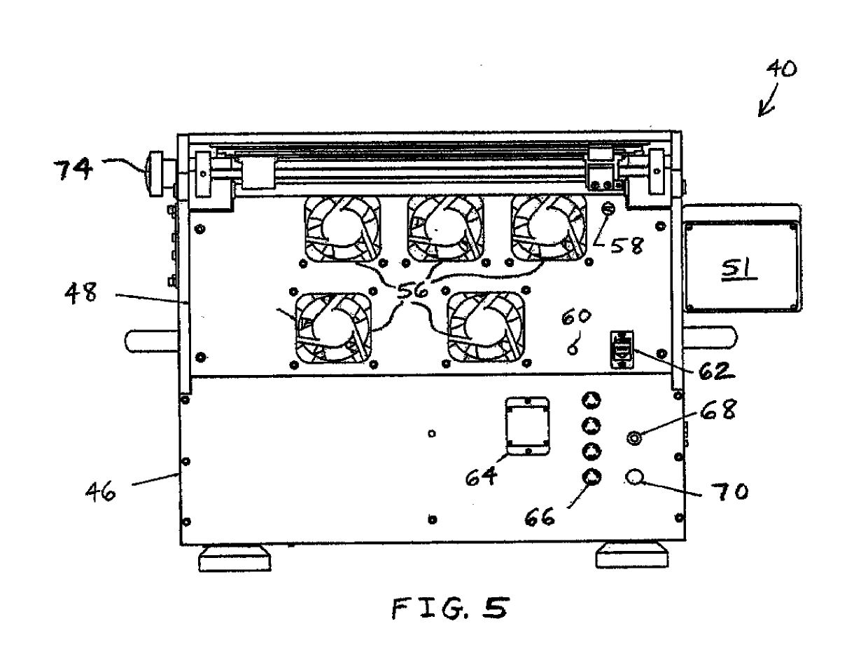

As a result of the paper traveling horizontally, all the electronics and electromechanical hammers are directly below (i.e., underneath) the paper. The backing plate of print head assembly 42, which is a solid ⅜ inch thick aluminum plate, efficiently transfers heat to the outside top of the unit, thereby maximizing heat dissipation. As an additional cooling means, fans 56, shown in FIG. 5, within the main chassis assembly 48 constantly pull air through embosser 40 to maintain a low internal temperature. These two cooling methods maintain the internal temperature of embosser 40 at a level that is extremely close to ambient temperature.

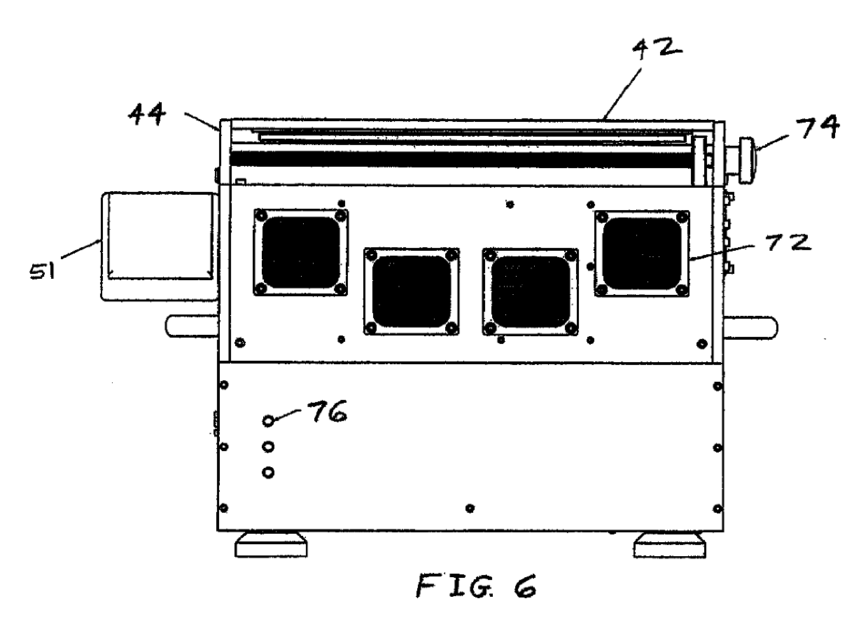

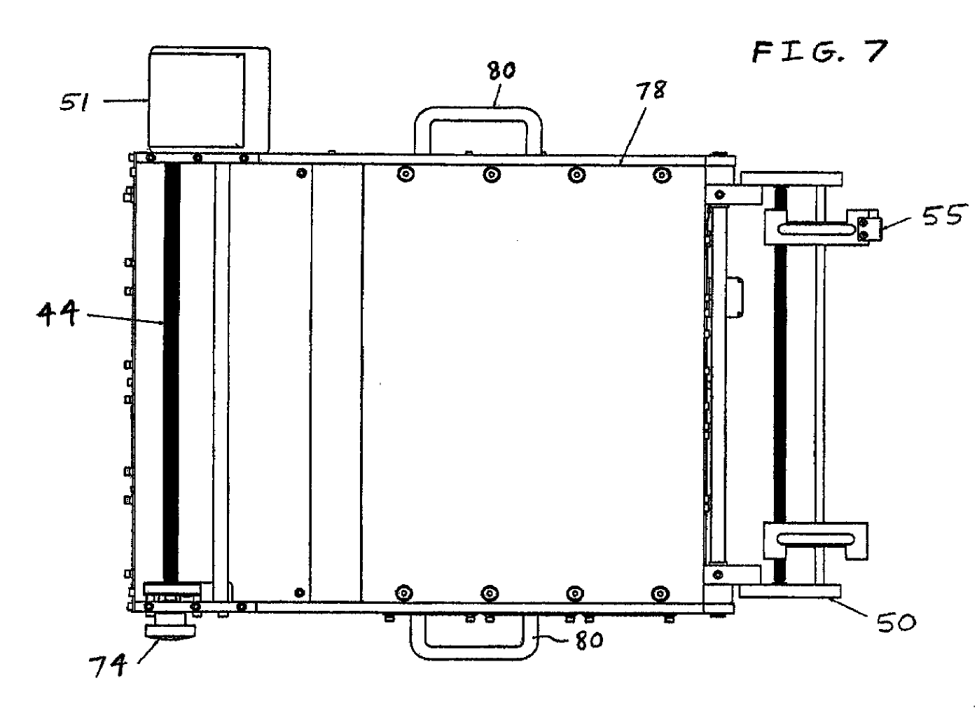

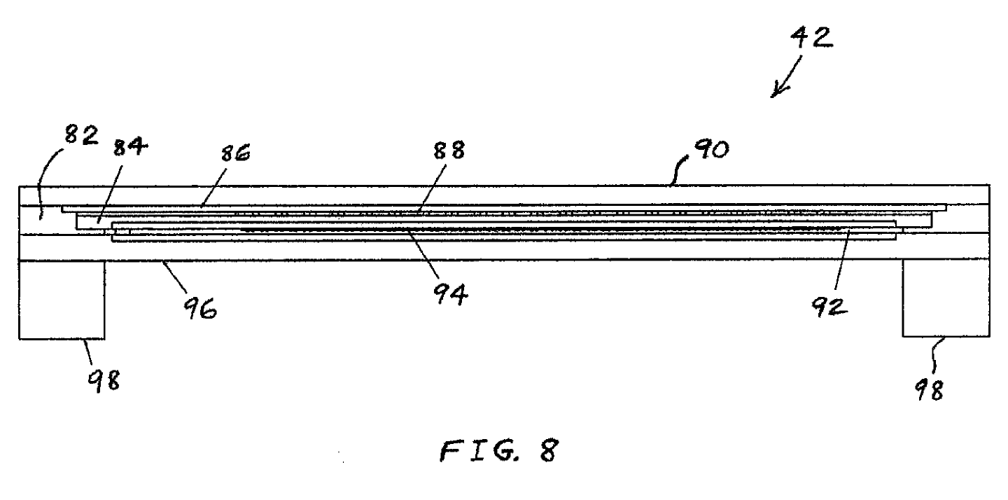

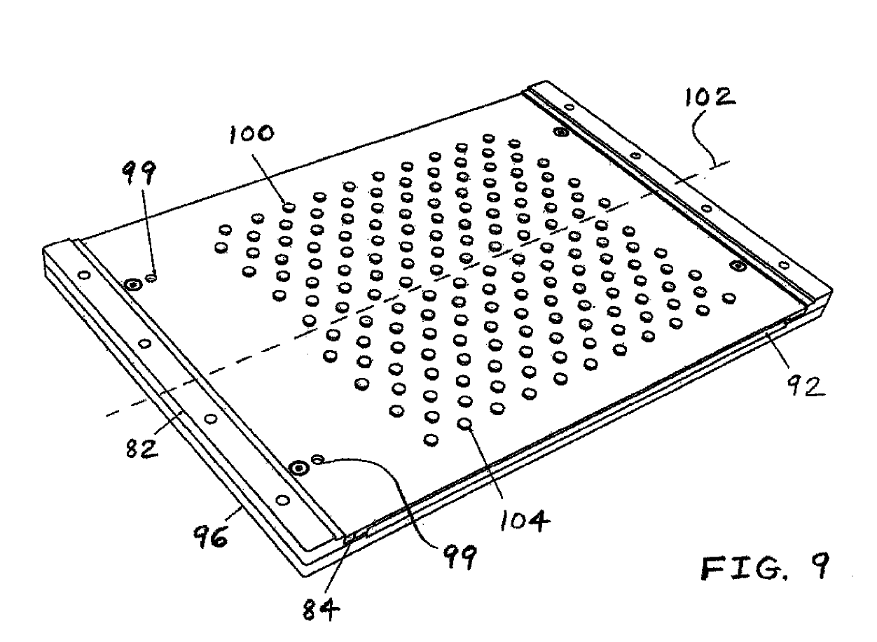

Also shown in FIG. 5 is a paper sensor connector 58, an external sensor/fan connector 60, an Ethernet connector 62, a power supply voltage select switch cover 64, fuses 66, a power switch 68, and a power entry port 70. Shown in FIG. 6 are air intake filters 72 by which cooling air is supplied to fans 56, a manual paper feed knob 74, and power indicators 76. Further shown in FIG. 7 are a print head assembly backing plate 78 and both handles 80.

FIG. 8 is a cross-sectional view of print head assembly 42 including an anvil plate mounting block 82, an anvil plate 84, a sheet of rubber backing 86, anvil backs 88, a backing plate 90, an air gap 92, anvil tips 94, a hammer plate 96, and mounting blocks 98. FIG. 9 is a perspective view of the print head assembly of FIG. 8 with backing plate 90 and rubber backing 86 removed. In addition to a pair of alignment pin holes 99, anvil plate 84 includes eighty-four positive, i.e., male, anvils 100 disposed to the upper left of an imaginary line of demarcation 102. Anvil plate 84 also includes eighty-four negative, i.e., female, anvils 104 disposed to the lower right of demarcation line 102.

Embossing is performed with a corresponding two-dimensional array of solenoids (i.e., hammers) including eighty-four positive hammers and eighty-four negative hammers that align with negative anvils 104 and positive anvils 100, respectively. Embosser 40 is capable of embossing a total of forty-two characters per line, with each character having two columns. Further, embosser 40 is capable of embossing the forty-two characters per line on each of the two opposite sides of a single sheet of paper (referred to as “interpoint embossing”). In order to produce the forty-two characters per line with two columns per character on each side of the page, a total of eighty-four hammers (solenoids) are provided per each of the two sides, for a total of 168 hammers.

FIG. 10, which is a plan top view of hammer plate 96, illustrates the staggering of the two groups of eighty-four hammers in the x-direction. All dimensions are in inches. Hammer plate 96 actually includes two groups of eighty-four through holes 106. It is to be understood that a respective hammer is to be inserted into each of through holes 106. In each of the two groups, each of the eighty-four hammers is disposed at a respective position in the x-direction. Thus, as the sheet of paper is passed by hammer plate 96 in the y-direction, each of the eighty-four hammers selectively punches a dot, or refrains from doing so, in each row in that hammer's respective one of the eighty-four columns on the page.

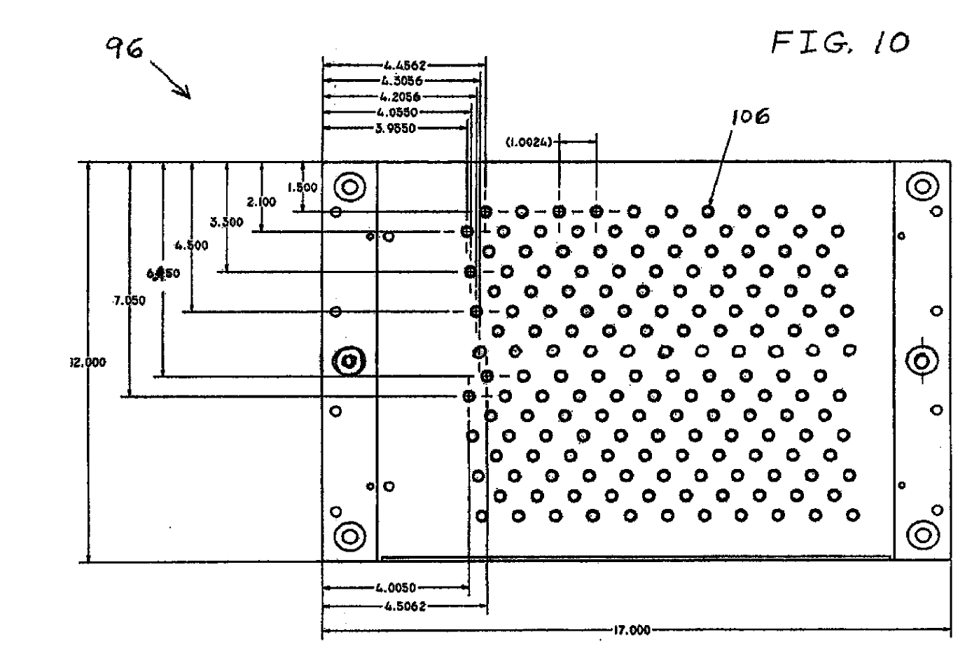

FIG. 11 is a schematic plan view of the layout of positive and negative dots on a sheet of paper as produced by the print head assembly of FIG. 8. Positive dots are indicated by circles, and negative dots are indicated by circles with an “X” therethrough. Positive dots may be defined as dots punched in a top to bottom direction, and negative dots may be defined as dots punched in a bottom to top direction. Thus, positive dots can be very close to negative dots as illustrated in FIG. 11 without impeding a reader's reading of the dots.

All dimensions provided in FIG. 11 are in inches. Each hammer is approximately 0.5 inch in diameter and the dots are 0.1 inch apart within a cell, with a distance of about 0.15 inch between cells. Thus, corresponding dots in vertically adjacent cells are 0.4 inch apart. The tight spacing indicated by these dimensions makes it impossible to place the hammers side-by-side in the same row. Rather, adjacent hammers have to be offset from one another in a transverse direction, i.e., in the y-direction, by a fixed distance in a repeating pattern. In the embosser design of the present invention, this spacing requirement is used to advantage for both cooling and power supply efficiency.

The Braille is always embossed on a fixed “grid” which makes up a page. There is only one X, Y position for each dot in any given cell which makes up that page. The paper must travel in the Y (vertical) axes in order to “expose” each hammer to every possible Y position. The hammers are laid out over varying fixed X and Y positions. The X positions are fixed based on the requirements of producing Braille, however the Y positions can be placed anywhere over the length of the page. The Y positions were carefully selected in order to maintain a large amount of air flow between all of the hammers for maximum cooling and to allow them to line up to their corresponding Y positions at “convenient” times. This means that since the Braille output is always constrained to a fixed grid, the hammer positions can be laid out so that their offsets allow them to not necessarily need to fire at all times. With the current layout pattern, only one-half of positions require all hammers to fire (if each hammer needs to fire in, depending on the document being embossed), and the other half of the positions require only half of the hammers to fire. The reason for this is the clever use of the blank line that always lies between rows of Braille cells. One-half of the time, all of the hammers lie in the three rows of the cells, meaning that all of the hammers could potentially need to fire. However, in the other half of the time, one-half of the hammers lie in the blank rows, meaning they will definitely not have to fire. This break from having to fire due to hammers lying in the blanks rows provides needed cooling time. The regularly occurring breaks from having to fire also allow the embosser to fire all the hammers that are needed to fire without having to wait between fires for the power supply to catch up to the large transient currents that occur during a fire. Thus, the peak power is constrained, which increases the speed and reliability of embosser 40.

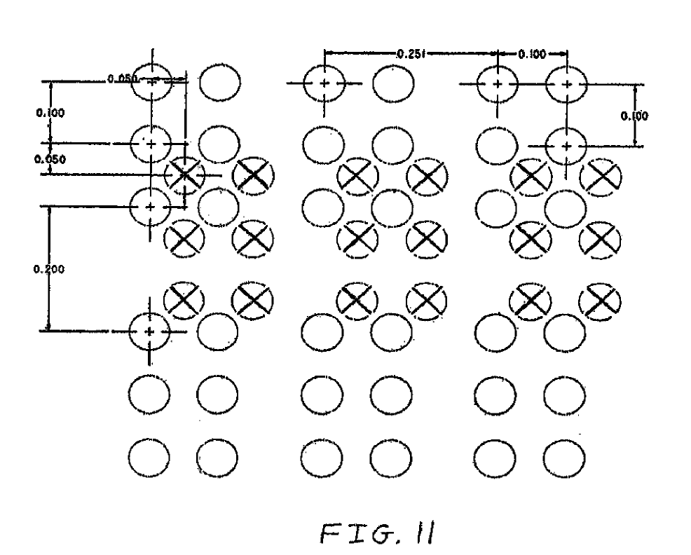

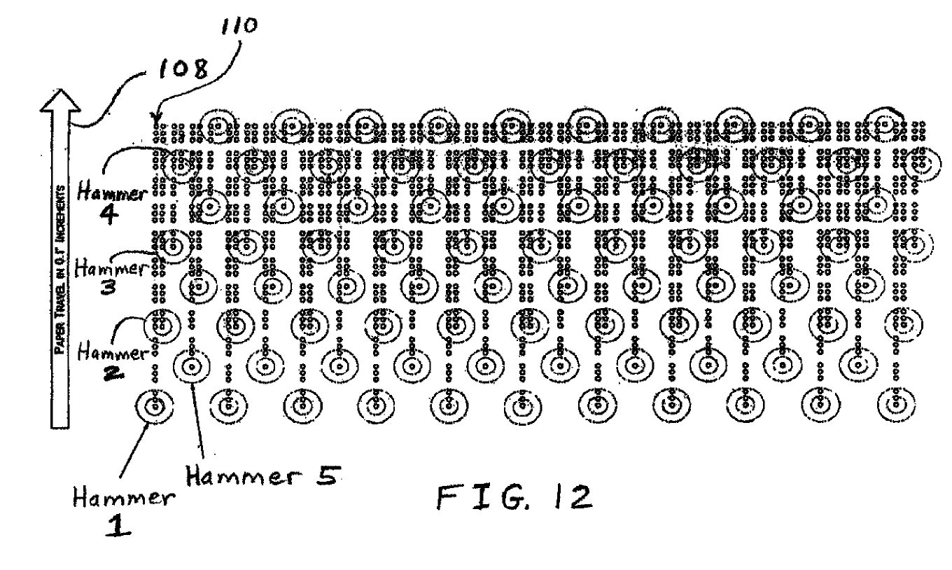

FIG. 12 is a schematic plan view of an embossing pattern produced by the print head assembly of FIG. 8. A direction of paper travel in 0.1 inch increments is indicated by arrow 108. FIG. 12 is a snapshot in time of dot locations, each dot location indicated by a respective circle, that have been passed by a hammer that is positioned to produce a dot at the location. That is, hammer 1, which produces dots in a first column 110 only, has passed by the dot locations of eleven cells in the vertical direction. Hammer 2, which produces dots in a second column only, has passed by the dot locations of eight cells in the vertical direction. Thus, hammer 2 is offset from hammer 1 by three cells in the vertical direction, which is 1.2 inch at 0.4 inch per cell. Hammers 3 and 4 are further offset by additional three cell distances in the vertical direction. Hammer 5, which produces dots in a fifth column only, is vertically located midway between hammers 1 and 2, i.e., hammer 5 is offset from each of hammers 1 and 2 by a distance of six rows of dot locations or rows between vertically adjacent cells. The locations of the remainder of the hammers, i.e., hammers 6 through 84, follow this same pattern, as is evident from FIG. 12.

FIG. 13 illustrates a first step of a four-step repeating fire sequence according to one embodiment of an embossing method of the present invention. FIG. 13 is a snapshot in time of an arbitrary position of the array of hammers relative to the dot locations of the cells. As can be seen in FIG. 13, each of hammers 1-84 is disposed such that it is superimposed over, or coincides with, one of the six dot locations within a cell.

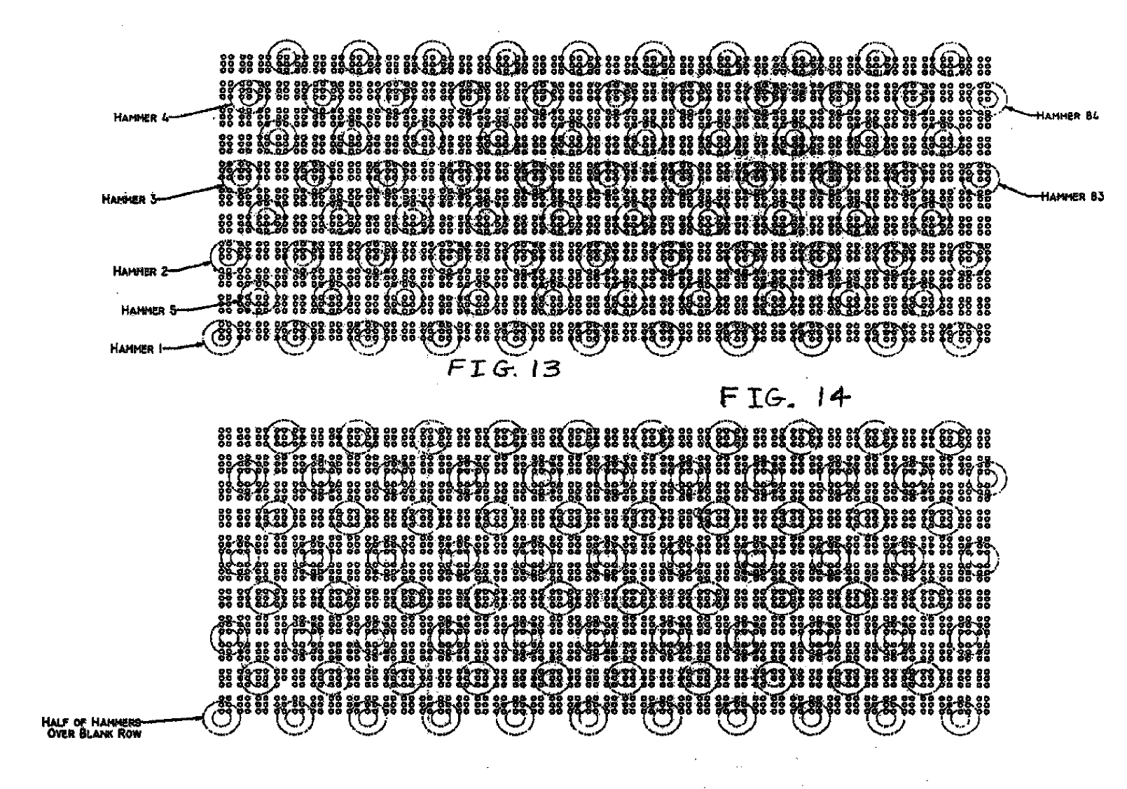

FIG. 14 illustrates a second step of the four-step repeating fire sequence. The paper has been moved by an increment of one row, e.g., 0.1 inch, in FIG. 14 relative to the position shown in FIG. 13. As can be seen in FIG. 14, only forty of the eighty-four hammers are positioned over a dot location, i.e., ten hammers in every other row. Each of the remaining forty-four hammers is positioned over a corresponding one of the horizontal blank rows that are disposed between vertically adjacent cells. Thus, none of these forty-four hammers may potentially fire in this position.

FIG. 15 illustrates a third step of the four-step repeating fire sequence. The paper has been moved by another increment of one row, e.g., 0.1 inch, in FIG. 15 relative to the position shown in FIG. 14. As can be seen in FIG. 15, as in FIG. 13, each of hammers 1-84 is disposed such that it is superimposed over, or coincides with, one of the six dot locations within a cell.

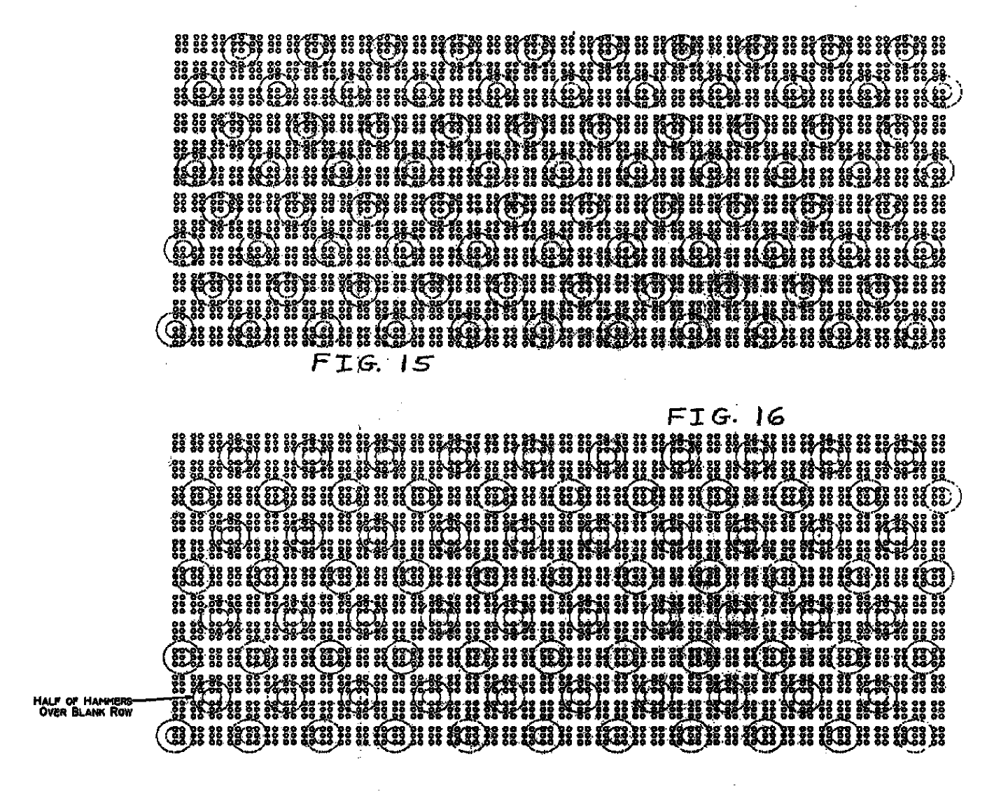

FIG. 16 is a fourth step of the four-step repeating fire sequence. The paper has been moved by an increment of one row, e.g., 0.1 inch, in FIG. 16 relative to the position shown in FIG. 15. As can be seen in FIG. 16, only forty-four of the eighty-four hammers are positioned over a dot location, i.e., eleven hammers in every other row. These forty-four hammers are the same forty-four hammers that were positioned in the blank line in the second step that is depicted in FIG. 14. Each of the remaining forty hammers is positioned over a corresponding one of the horizontal blank rows that are disposed between vertically adjacent cells. Thus, none of these forty hammers may potentially fire in this position. These forty hammers are the same forty hammers that were positioned over dot locations in FIG. 14. A further one row (0.1 inch) incremental move of the paper returns the process back to the first step that is depicted in FIG. 13, and the above-described sequence continues.

In another aspect of the present invention, pulse width modulation is used to control the electrical power of the hammer punches. The mechanical impact level (i.e., strength) of the hammer punch is directly proportional to the level of effective current passed through the hammer coil. Using a Pulse Width Modulation (PWM) technique, this effective current level is controlled. During a fire pulse, a varying-duty cycle PWM control signal 32 (FIG. 2) is ANDed at 34 with a fire pulse 36, effectively modulating the fire pulse with a current control pulse. By varying the pulse width (duty cycle) of the modulating signal, the effective hammer current is controlled. Because the voltage may be held constant, the effective hammer power may also be controlled. This technique greatly reduces the complexity of controlling a large number of hammers and is also very efficient. Because the transistor driver 30 which controls the hammer (“RLOAD” in FIG. 2) is either “full on” or “full off,” transistor driver 30 has to dissipate very little power, thereby maximizing efficiency and reducing the heat generated by drive electronics to a minimum.

Due to the PWM control of the hammers, the electrical feedback system becomes more complicated. With the modulated current control signal constantly removing power to the hammer at a high frequency, the possibility for erroneous data from the electrical feedback circuits is inevitable. To counter this problem, the PWM frequency is carefully selected in view of the rate at which the hammer fault circuits can be read during a fire. Using a summed reading approach, a reliable indication of faults can be acquired regardless of the PWM control of the hammers. Statistically, this holds true for the normal operation of the embosser. However, for very low PWM duty cycles false faults will occur. This, however, only occurs below the effective level of control and is not an issue for normal operation.

All 168 hammers are controlled in groups of eight via a total of twenty-two eight-bit registers. Each of these registers employs an OE (output enable) line to which the PWM control signal is ANDed, as at 34 (FIG. 2), with the fire signal in order to control the power to the hammers. Each of these twenty-two registers is supplied a different physical PWM line, and each of the PWM lines is individually controllable in its duty cycle. Thus, hammers in groups of eight are enabled to have completely different effective current levels. This provides the ability to increase the power to certain hammer areas as the embosser ages and wears in order to extend the useful life of the hammers. In another embodiment, each of 168 separate PWM lines are individually controllable in their duty cycles, and thus a different, controllable level of power may be provided to each of the 168 hammers. In addition to compensating for wearing of the hammers, the adjustability of the power to the hammers may enable embosser 40 to be customized for particular output requirements, such as depth of dots.

As described in more detail below, embosser 40 may include a mechanical hammer fault feedback system. Embosser 40 includes sensors that detect the mechanical state of the hammers and other components of embosser 40 and accordingly provide feedback to control the hammer power supply. Thus, the power level provided to each of the hammers, or at least to each group of eight hammers, may be continually adjusted as a function of hammer wear, hammer impact force, other physical conditions within embosser 40, and/or environmental conditions.

Positive anvils 100 and negative anvils 104 (FIG. 9), which are impacted by the hammers, are fitted loosely into anvil plate 84 and are backed by sheet of rubber 86 and backing plate 90 in order to absorb shock yet remain mostly rigid. A mechanical feedback system may be provided on the print head assembly. Essentially, backing plate 90 and rubber sheet 86 at the top level of print head assembly 42 may be replaced by an impact-sensing subassembly. The impact sensing apparatus may be in the form of a strain gage in a load cell configuration, for example. The load cell may be placed behind each anvil and may be capable of sensing the force of the impact imparted to the anvil by the hammer. Another possible sensor apparatus is in the form of a touch-sensitive membrane.

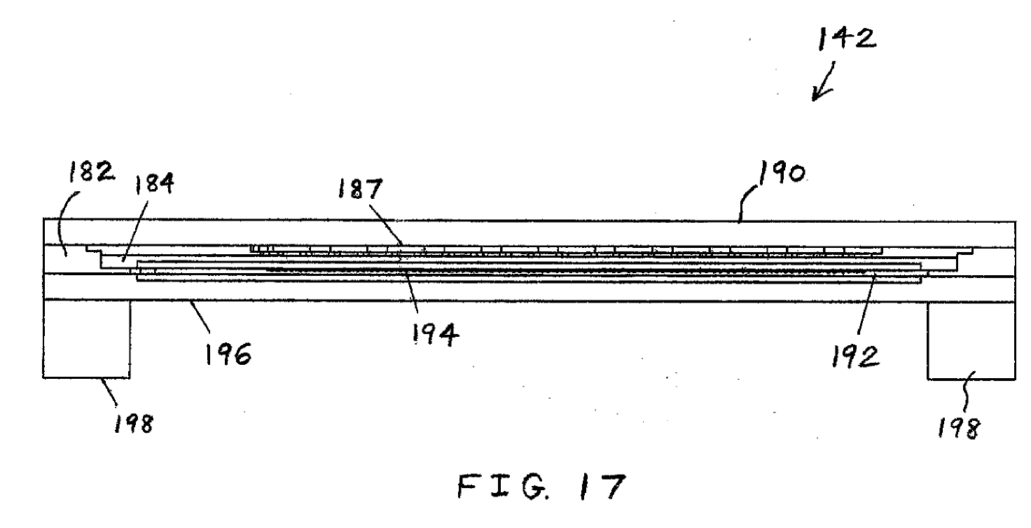

An embodiment of a print head assembly 142 including a mechanical feedback system is illustrated in FIG. 17. More particularly, print head assembly 142 includes an anvil plate mounting block 182, an anvil plate 184, load cells 187, a backing plate 190, an air gap 192, anvil tips 194, a hammer plate 196, and mounting blocks 198.

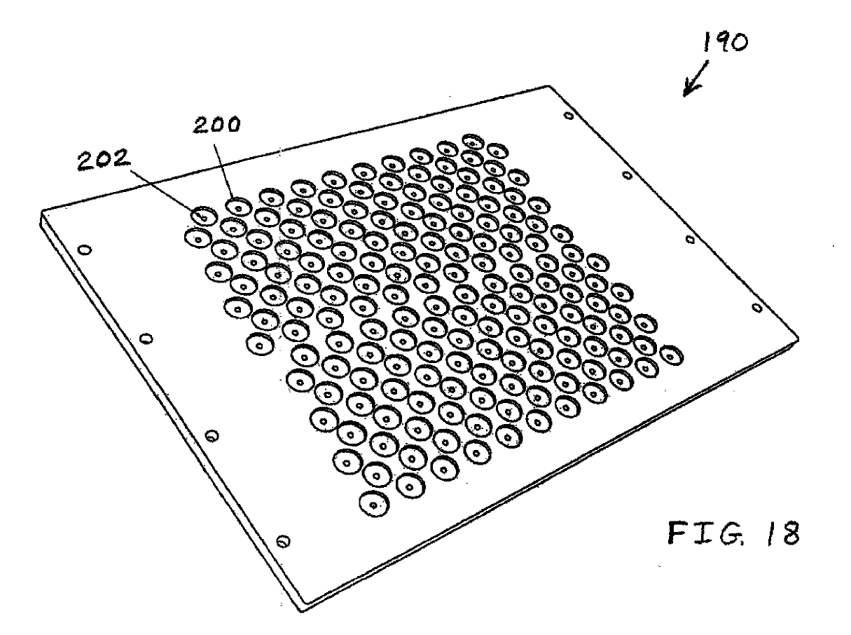

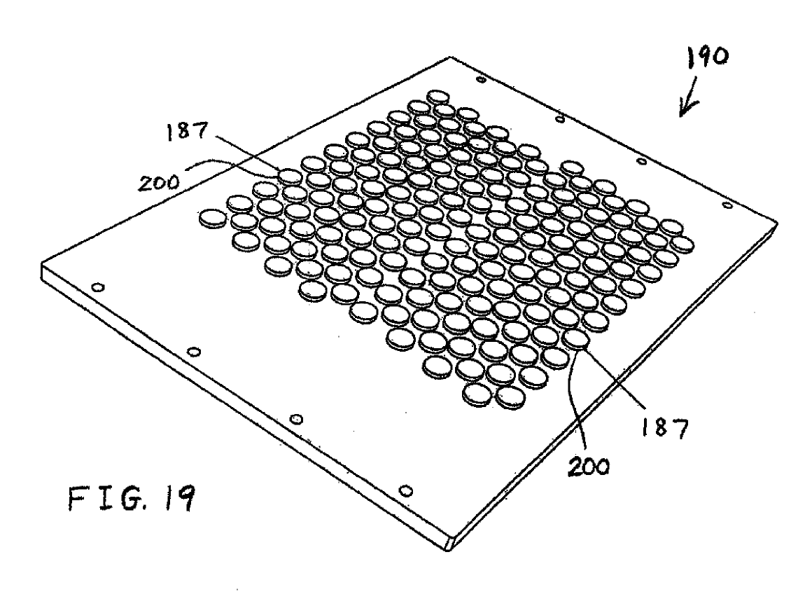

Backing plate 190 includes a total of 168 load cell-mounting counterbores 200 (FIG. 18). Each counterbore 200 includes a respective through hole 202 for allowing pass through of load cell wires. FIG. 19 illustrates backing plate 190 with load cells 187 for both positive and negative anvils mounted within counterbores 200.

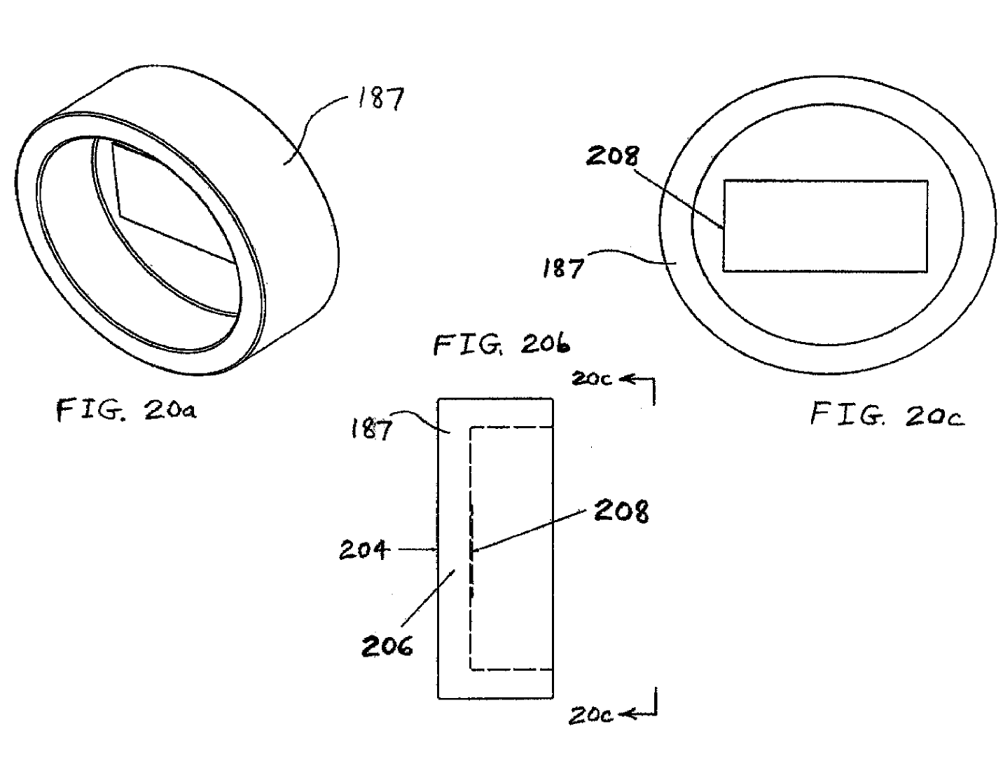

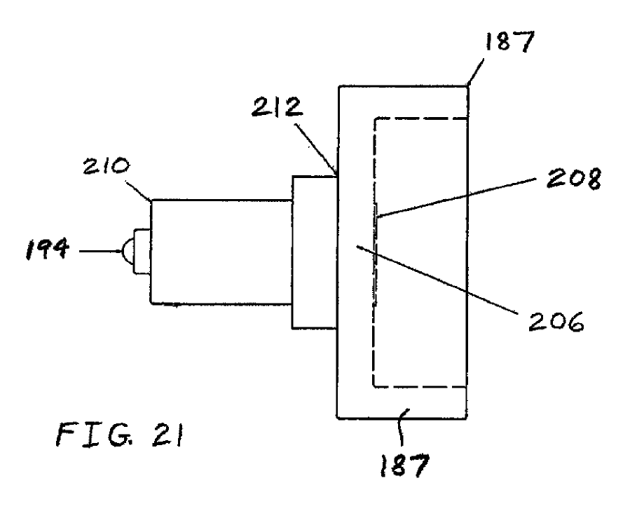

FIGS. 20a-c illustrate a load cell 187 in more detail. Upon striking of a respective hammer, force from the anvil may be applied at 204 to a deflection membrane 206. A strain gage 208 measures a magnitude of the force applied to membrane 206.

FIG. 21 illustrates the engagement of deflection membrane 206 by an anvil 210. Upon an impact from a hammer at anvil tip 194, anvil 210 engages, and exerts a force upon, deflection membrane 206 at mechanical interaction area 212.

By use of a mechanical hammer fault feedback system, as described above, various problems can be detected. Advantageously, a hammer which fails mechanically can be detected immediately, even if it appears to be electrically sound. With proper analysis of the sensor data, it is possible to determine the effectiveness of the hammer at producing dots. If the effectiveness of the hammer is found to be lacking, the electrical power to the bank to which the hammer is connected may be increased, or the need for replacement of the hammer may be indicated.

In addition to load cells and pressure sensors, other means of confirming a sufficient level of hammer force may include optical sensors or sensors in which the impact of the hammer opens or closes an electrical circuit.

What is claimed is:

1. A braille embosser device, comprising:
a plurality of hammers configured to strike a substrate and thereby produce thereon braille-readable projections; and
a controller connected to the hammers and configured to control the striking by the hammers, the controller including:
a plurality of drivers, each of the drivers being connected to and configured to drive a respective one of the hammers; and
a fault detection circuit configured to detect a fault associated with one of the drivers and, in response to the fault, cease the striking by the hammers.

2. The braille embosser device of claim 1, wherein the fault detection circuit includes a plurality of transistors, each of the transistors including a high side connected to a respective one of the hammers, a gate of each of the transistors being configured to receive a respective hammer fire signal.

3. The braille embosser device of claim 2, wherein the a fault detection circuit is configured to detect a fault associated with one of the drivers dependent upon a state of the respective hammer fire signal and a state of a feedback signal at the high side of a respective one of the transistors.

4. The braille embosser device of claim 3, wherein the controller includes a processor receiving the feedback signals and the hammer fire signals.

5. The braille embosser device of claim 3, wherein the fault detection circuit is configured to detect a hammer fault condition both when the hammer fire signal is in a low state and when the hammer fire signal is in a high state.

6. The braille embosser device of claim 1, wherein the controller is configured to stop operation of the embosser device upon a fault associated with one of the drivers being detected.

7. The braille embosser device of claim 1, further comprising a hammer power supply coupled to the hammers, the controller being configured to discharge the hammer power supply upon a fault associated with one of the drivers being detected.

8. A braille embosser device, comprising:
a plurality of hammers configured to strike a substrate and thereby produce thereon braille-readable projections; and
a controller connected to the hammers and configured to control the striking by the hammers, the controller including:
a plurality of drivers, each of the drivers being connected to and configured to drive a respective one of the hammers; and
at least one sensor arrangement configured to sense the striking by the hammers and control the drivers dependent upon the sensed striking by the hammers.

9. The braille embosser device of claim 8, wherein the sensor arrangement is configured to determine from the striking of the hammers whether a resultant one of the projections is formed within specifications.

10. The braille embosser device of claim 8, wherein the sensor arrangement is configured to sense a magnitude of force associated with the striking of the hammers.

11. The braille embosser device of claim 8, wherein the embosser device includes a plurality of anvils configured to support the substrate against the striking by the hammers, the sensor arrangement including a plurality of load cells configured to engage the anvils upon the striking of the hammers.

12. The braille embosser device of claim 8, wherein the controller is configured to provide a first level of electrical current to a first one of the hammers while simultaneously providing a second level of electrical current to a second one of the hammers.

13. The braille embosser device of claim 12, wherein the controller is configured to pulse width modulate the electrical currents provided to the hammers and adjust the levels of the currents by varying duty cycles of the pulse width modulation.

14. The braille embosser device of claim 8, wherein the controller is configured to adjust current levels provided to the hammers in order to maintain the striking by the hammers at a constant level of force as conditions within the embosser device change.

15. A braille embosser device, comprising a two-dimensional array of hammers configured to strike a substrate and thereby produce thereon braille-readable dots, the dots being arranged in braille cells of six dots, the cells being arranged in rows extending in an x-direction and columns extending in a y-direction, each of the hammers having a different, respective position in the x-direction, each pair of hammers that have adjacent positions in the x-direction being offset in the y-direction from each other by a distance equivalent to at least three of the braille cells.

16. The braille embosser device of claim 15, wherein each said pair of hammers that have adjacent positions in the x-direction are offset in the y-direction from each other by a distance of at least one inch.

17. The braille embosser device of claim 15, further comprising a controller configured to feed the substrate past the hammers such that during approximately one-half of hammer firings all of the hammers coincide with dot locations on the substrate, and during an other approximate one-half of hammer firings about one-half of the hammers coincide with spaces between the dot locations.

18. The braille embosser device of claim 15, wherein the array of hammers includes eight rows of the hammers, each said row extending in the x-direction perpendicular to a direction of substrate feed.

19. The braille embosser device of claim 18, wherein two outermost rows of the eight rows are offset from each other by a distance equivalent to at least ten cells in the y-direction.

20. The braille embosser device of claim 18, wherein a fifth left-most one of the hammers is disposed approximately midway between a first left-most one of the hammers and a second left-most one of the hammers in the y-direction.
